(19) United States
(12) Patent Application Publication
(10) Pub. No.: US 2012/0285397 A1
(43) Pub. Date: Nov. 15, 2012

(54) Method and apparatus for broadcasting to a dog handler the disposition of an approaching dog

(76) Inventor: Trudi Sharpsteen, Hermosa Beach, CA (US)

(21) Appl. No.: 13/068,321

(22) Filed: May 9, 2011

(51) Int. Cl. A01K 27/00

(52) U.S. Cl. 119/858

(57) ABSTRACT

Method and apparatus for communicating to a person handling a dog the behavioral temperament of an approaching dog using color coded material, each color representing a different temperament of the approaching dog.

### BACKGROUND OF THE INVENTION

1. Field of the Invention

The present invention relates to a method for a first dog handler to provide a visual warning to a second dog handler regarding the current disposition or temperament of a dog being handled by the first dog handler.

2. Description of the Prior Art

It is not uncommon for a dog handler walking his/her dog in an area where other dogs may congregate, to have the dog interact with another dog in various ways such as barking, biting, or the like. In this regard, dog handlers typically have no way of inquiring of their fellow dog handlers before the dogs meet as to whether the meeting is appropriate. Instead, the dogs get close and then act in one or more of the ways noted hereinabove.

What is thus desired is to provide a method and apparatus for communicating to dog handlers whether the disposition of an approaching dog is such that a meeting would be appropriate.

### SUMMARY OF THE INVENTION

The present invention provides color coded dog markers of various shapes that are designed to provide advance notice to dog handlers about the disposition of an approaching dog. In particular, the present invention is a broadcast system for a dog handler that proactively communicates to another dog handler as to whether the dogs should meet.

The proactive dog handler secures a color coded material, such as cloth around the neck of the dog, the cloth being sized so that it is visible to oncoming dog handlers. The clothing may be a bandana stretched to spread across the dog's upper back for purposes of visibility. The material could be worn by a dog all day or secured when the dog is to be taken for a walk or run.

The material preferably is color coded as follows:

1. Green: Green means that the dog is generally friendly with others and that this is a good opportunity to let the dogs meet.

2. Orange: Orange means that the dog might be interested in meeting but the handler's should talk first and use caution.

3. Red: Red means that the dog is generally not welcoming of other dogs.

An alternate technique is to provide matching collars that light up at night (with the appropriate color) and a purple color version for puppies under 4 months who have not yet received their shots.

### DESCRIPTION OF THE DRAWINGS

For a better understanding of the present invention as well as other objects and further features thereof, reference is made to the following description which is to be read in conjunction with the accompanying drawing therein:

FIGS. 1(a)-1(f) show different shapes of a color coded material for illustrating the current disposition of a dog;

FIG. 2 illustrates a first embodiment for attaching a color coded material to a dog collar;

FIG. 3 illustrates a second embodiment for attaching a color coded material to a dog collar; and

FIG. 4 illustrates the embodiment shown in FIG. 3 attached to the neck of a dog.

### DESCRIPTION OF THE INVENTION

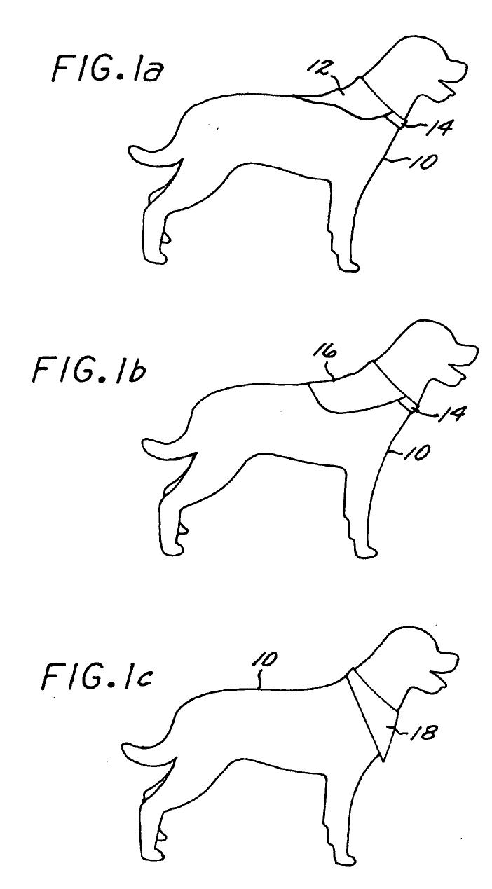

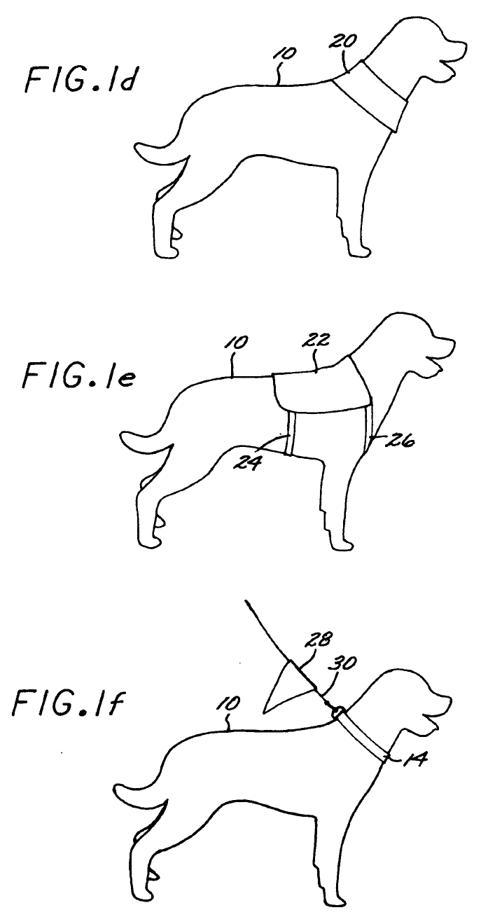

FIGS. 1(a)-1(f) illustrate various shaped materials that exemplify the type of communicating device attached to dog 10 as contemplated by the present invention. In particular, FIG. 1(a) shows a bandana shaped device 12 attached to dog collar 14, FIG. 1(b) shows a square shaped device 16 attached to collar 14, FIG. 1(c) shows a triangular shaped device 18 attached to collar 14 (not shown), FIG. 1(d) shows a rectangular shaped device 20 attached to collar 14 (not shown), FIG. 1(e) shows a rectangular shaped device 22 attached to dog 10 via straps 24 and 26, and FIG. 1(f) shows device 28 formed as a pendant attached to leash 30, leash 30 in turn being coupled to dog collar 14.

The devices are preferably coded as follows:

1. Green: Green means that the dog is generally friendly with others and that this is a good opportunity to let the dogs meet.

2. Orange: Orange means that the dog might be interested in meeting but the handlers should talk first and use caution.

3. Red: Red means that the dog is generally not welcoming of other dogs.

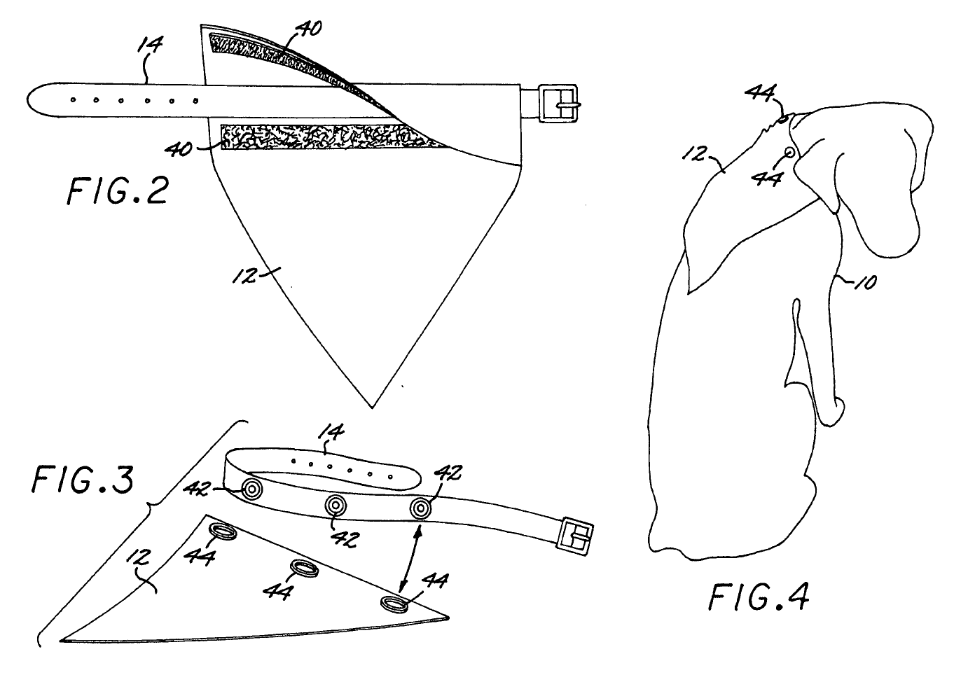

In order to illustrate how a communication device is coupled to a dog, FIG. 2 shows one way to couple the device 12 shown in FIG. 1(a) to dog collar 14. In particular, a Velcro loop and hook connection system 40 is attached to opposite inner surfaces of the device in a manner such that the bandana surrounds collar 14.

FIG. 3 illustrates an alternate way to connect device 12 to dog collar 14. In particular, a set of snap button receptacles 42 are formed on the outer surface of dog collar 14 and corresponding snap buttons 44 are formed on the interior surface of device 12.

FIG. 4 shows device 12 secured on dog 10 using the connection system shown in FIG. 3.

The method of the present invention works as follows:

1. The dog handler determines as accurately as possible the temperament of the dog prior to leaving the dog enclosure;

2. The dog handler selects, from a series of three devices, one of which is in the color green, the second in orange and the third in red, the appropriate color; and

3. The selected color coded device is then attached to the dog.

The three color coded devices can be sold as a set; if the device being sold is as shown in FIG. 3, the modified dog collar can be included in the set. The packaging for the set provides the dog handler directions for determining what color coded device is appropriate for what temperament/disposition. In addition, graphics can be utilized on the color coded devices themselves which includes the specific use message for that color.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A method for communicating to a person handling a dog the temperament of an approaching dog comprising the steps of:
providing a first material of a first preselected color;
removably securing said material to the dog collar of the approaching dog; and
attaching said dog collar to the neck of a dog prior to leaving a dog enclosure.

2. The method of claim 1 comprising the further steps of:
removing said first material from said dog collar;
providing a second material of a second preselected collar; and
securing said second material to said dog collar.

3. The method of claim 1 wherein said first color indicates that the approaching dog has a first behavioral temperament towards the dog being handled by said person.

4. The method of claim 2 wherein said second color indicates that the approaching dog has a second behavioral temperament to the dog being handled by said person, said first behavioral temperament being different than said second behavioral temperament.

5. A system for communicating to a person handling a dog the temperament of an approaching dog comprising:
a first material of a first color, said first color representing a first behavioral temperament of the approaching dog;
a second material of a second color, said second color representing a second behavioral temperament of the approaching dog; and
means for securing either said first or second material to the collar of said approaching dog prior to the dog leaving a dog enclosure.
